(19) United States
(12) Patent Application Publication
(10) Pub. No.: US 2005/0271112 A1
(43) Pub. Date: Dec. 8, 2005

(54) Fastening arrangement for a laser pump module

(76) Inventors: Martin Liermann, Villingen Schwenningen (DE); Christian Schmitz, Dunningen (DE); Andreas Voss, Schramberg (DE)

Correspondence Address: FISH & RICHARDSON PC, P.O. BOX 1022, MINNEAPOLIS, MN, 55440-1022, US

(21) Appl. No.: 11/138,914

(22) Filed: May 27, 2005

(30) Foreign Application Priority Data
May 29, 2004 (EP) 04 012 845.6

(51) Int. Cl. H01S 3/09; H01S 3/093; H01S 3/00

(52) U.S. Cl. 372/72; 372/69; 372/109

(57) ABSTRACT

A mounting apparatus includes at least one diode laser pump module having a module bearing surface and connectors on a bearing side of the pump module, a carrier having at least one carrier bearing surface and counter connectors on a bearing side of the carrier, wherein the module is insertable onto the carrier, and a holder configured to hold the module bearing surface of the at least one pump module in abutment against the carrier bearing surface of the at least one carrier, such that a connection is formed between the connectors and the counter connectors.

### CLAIM OF PRIORITY

This application claims priority under 35 USC § 119 to European Patent Application Serial No. 04 012 845.6, filed on May 29, 2004, the entire contents of which are hereby incorporated by reference.

### TECHNICAL FIELD

This disclosure relates to an arrangement for fastening at least one laser pump module to a laser pump module carrier

### BACKGROUND

Liquid-cooled high-performance diode laser stacks are increasingly used for exciting solid state lasers, in particular, disc lasers. Depending on the output power of the solid state laser, several such diode stacks may be required for exciting the solid state laser. Since the stacking height of the diode laser stacks is limited for technical and economic reasons, several stacks often are combined by a suitable optical system and imaged on the laser-active solid.

The laser diode stacks are subject to wear, and replacement must be possible in case of degradation or defect. Usually, either only the laser diode stacks or an entire structural component, which includes the diode stack and facilitates replacement, are replaced. This structural component may comprise a housing with optics and electronics and is referred to herein as a pump module.

German patent publication, DE 197 49 328 A1, discloses such a pump module for a diode-pumped bar laser. Adjustment after exchange of the pump module is not necessary since the housing of the pump module reproduces the defined spatial position of the diode stack relative to the laser bar. However, the user must produce further interfaces (e.g., cooling, data transfer, current supply), which are required for operating the laser, using suitable tools. These assembly steps require time and increase the inoperative time of the laser, and correct performance of the required assembly steps additionally requires special skills. The likelihood of assembly mistakes, which could cause failure of the device, increases with the number of assembly steps.

### SUMMARY

A fastening arrangement for a pump module is disclosed in which the pump module (e.g., a replacement pump module) can be fastened to a carrier with minimum effort and without tools. The pump module has a bearing surface and connections on a bearing side and the carrier has a bearing side with at least one bearing surface and counter connections. A holder holds the bearing surface of the pump module in abutment against the bearing surface of the carrier, thereby forming a connection between the connections and counter connections.

In a first general aspect, a mounting apparatus includes at least one diode laser pump module having a module bearing surface and connectors on a bearing side of the pump module, a carrier having at least one carrier bearing surface and counter connectors on a bearing side of the carrier, wherein the module is insertable onto the carrier, and a holder configured to hold the module bearing surface of the at least one pump module in abutment against the carrier bearing surface of the at least one carrier, such that a connection is formed between the connectors and the counter connectors.

Implementations can include one or more of the following features. For example, the pump module can include an outlet window at a front end of the module and a pivot bearing, and the carrier can include a counter pivot bearing on which the pivot bearing of the pump module engages in the mounted state. The pivot bearing of the pump module can be separated from the module bearing surface of the pump module. The pivot bearing of the pump module can be formed by one or more bearing recesses in front end of the module, and the counter pivot bearing of the carrier can be formed by one or more swivel pins. The counter pivot bearing of the carrier can be adjustable along a direction in which the module is insertable onto the carrier, its distance from the bearing surface of the carrier, and about an axis that extends perpendicularly to the bearing surface of the carrier. The pump module can include a projection at its front end, and where the carrier can include a corresponding recess, where the projection and the recess mutually engage without lateral play when the pump module is inserted onto the carrier. The pump module can include a recess at its front end, and the carrier can include a corresponding projection, where the projection and the recess mutually engage without lateral play when the pump module is inserted onto the carrier.

The connections between the connectors and counter connectors can include an electric power connection for providing electrical power to the module, a cooling connecting for providing cooling to the to the pump module, a flowing gas connection for providing flowing gas to the pump module, and a data transfer connection for transferring data between the pump module and the carrier. The cooling connection can include a connector on the pump module having a seal, and a counter connector on the carrier having a flat sealing surface, where the seal is pressed against the sealing surface by the holder. The flowing gas connection can includes a connector on the pump module having a seal and a counter connector on the carrier having a flat sealing surface, where the seal is pressed against the sealing surface by the holder. The electric power connection can include a connector on the pump module having flat contacts, and a counter connector on the carrier having flat contacts, where the flat contact of the connector and the counter connector are pressed against the sealing surface by the holder. The data transfer connection can includes a plug on the pump module, and a plug on the carrier, where the plug on the pump module and on the carrier are floatingly disposed on the pump module and on the carrier. The connections between the connectors and the counter connectors can include a flowing gas connection for providing flowing gas to the pump module and a data transfer connection for transferring data between the pump module and the carrier, where the connector of the cooling connection is provided on the bearing side of the pump module in a plane that is lower than a plane in which the connector of the data transfer connection and the current supply connectors are provided.

The holder can include one or more tension levers that tension the bearing surface of the pump module into abutment against the bearing surface of the carrier. The holder can includes a tension lever that tensions the pivot bearing of the pump module along a direction in which the pump module is inserted into the carrier against the counter pivot bearing of the carrier and that tensions the bearing surface of the pump module lying against the counter pivot bearing into abutment against the bearing surface of the carrier. The tension lever can be supported on the carrier and can engage with an end of the pump module opposite the front end of the module. The carrier can include a plurality of bearing surfaces located adjacent to each other, each bearing surface having counter connectors and counter pivot bearings for receiving a pump module. The bearing surfaces can be disposed along a circular arc and optics disposed within the circular arc and combine output laser beams from all pump modules inserted onto the carrier into one common laser beam.

In another general aspect, a method of fastening a laser pump module to a carrier, where the laser pump module includes a module bearing surface, recesses, and connectors on a bearing side of the pump module and where the carrier includes at least one carrier bearing surface, swivel pins, and counter connectors on a bearing side of the carrier, can include inserting the pump module along an insertion direction onto the carrier, such that recesses of the pump module engage swivel pins of the carrier to locate the pump module in a pre-determined position on the carrier and engaging a holder to hold the module bearing surface of the pump module in abutment against the carrier bearing surface of the at least one carrier, such that connections are formed between the connectors and the counter connectors.

The details of one or more implementations are set forth in the accompanying drawings and the description below. Other features will be apparent from the description and drawings, and from the claims.

### DESCRIPTION OF DRAWINGS

FIG. 1 is a schematic top view of a carrier to which several pump modules can be fastened.

FIG. 2 is a schematic view of a bearing side of a pump module that can be fastened to the carrier shown in FIG. 1.

FIG. 3 is a schematic side view of a pump module fastened to a carrier.

Like reference symbols in the various drawings indicate like elements.

### DETAILED DESCRIPTION

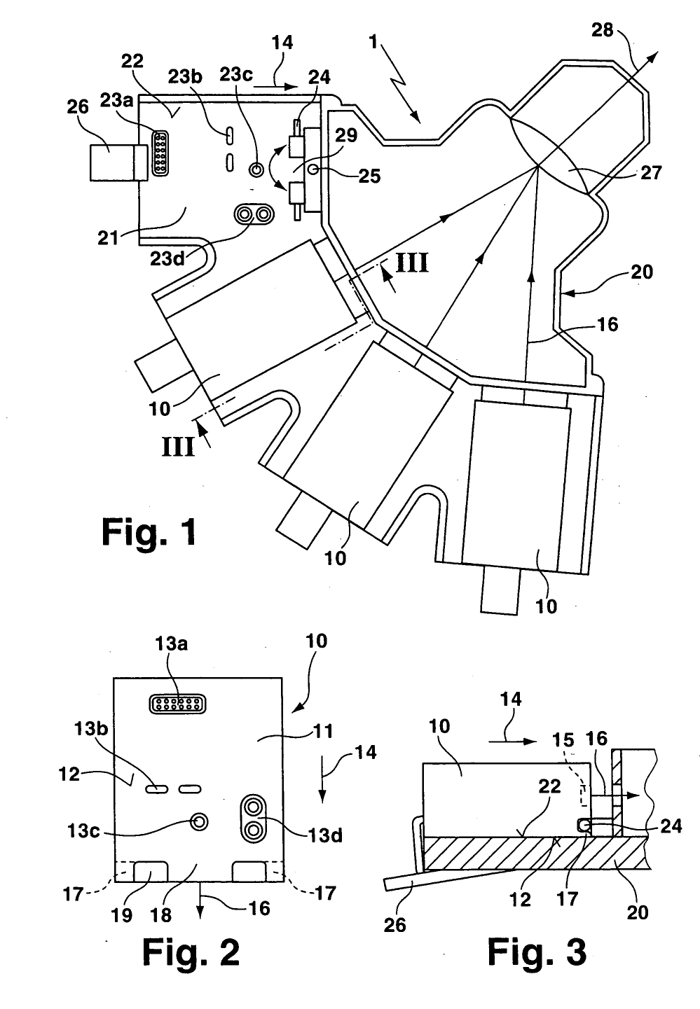

As shown in FIG. 1, an arrangement 1 between a fan-shaped carrier 20 and four pump modules 10 serves to fasten the pump modules 10 to the carrier 20. The pump modules 10 contain diode laser stacks for pumping a high-performance solid state laser (not shown). The module housing protects the diode laser stacks from environmental influences (e.g., splashing water, dust, contact, mechanical influences). The module housing is designed such that the diode laser stack can be kept dust-free, dry and solvent-free using flowing air.

As shown in FIG. 2, the pump module 10 has a flat bearing surface 12 and connections 13a, 13b, 13d, and 13d on its bearing side 11. At the front end of the module (as viewed in the insertion direction 14) is an output opening or outlet window 15 (shown in FIG. 3) for a laser beam 16 of the diode laser stack and a pivot bearing 17. The pivot bearing 17 is formed by two bearing recesses that open in a direction opposite to the insertion direction 14 and that define a pivot axis that extends parallel to the bearing surface 12 and perpendicular to the insertion direction 14. A central projection 18 is provided between the bearing recesses, and the central projection 18 is separated on each side from the bearing recesses by a recess 19. The outlet window 15 may be open or closed by a window, for example, in the form of a lens or a plane-parallel plate.

A bearing side 21 of the carrier 20 has a flat bearing surface 22 and counter connections 23a, 23b, 23c, and 23d for each pump module 10 and a counter pivot bearing 24 at its front end (as viewed in the insertion direction 14) for receiving a pump module. The counter pivot bearing 24 is formed by two swivel pins that can be adjusted in the insertion direction 14 and in their distance from the bearing surface 22 and/or about the axis 25 (shown by the double arrow) using adjusting screws (not shown). A recess 29 is provided between the swivel pins. A holder 26 in the form of a tension lever is provided at the rear end of the carrier 20 (as viewed in the insertion direction 14), is supported on the carrier 20 and has a free end that engages on the pump module 10.

Thus, the pivot bearing 17 of the pump module 10 is formed by one or more bearing recesses that open in a direction opposite to the insertion direction 14, and the counter pivot bearing 24 of the carrier 20 is formed by one or more swivel pins. To prevent lateral displacement of the pump module 10, the pump module 10 includes a projection at its front end (as viewed in the insertion direction 14), and the carrier 20 has a corresponding recess (or vice versa), wherein the projection and recess mutually engage without lateral play when the pump module 10 is fastened to the carrier 20.

For fastening the pump module 10 on the carrier 20, the pump module 10 is slid onto the carrier 20 in the insertion direction 14 at an angle of approximately 5° to approximately 30° relative to the bearing surface 22, until the pivot bearing 17 abuts against the counter pivot bearing 24. The central projection 18 thereby engages in the recess 29 of the carrier 20 on the pump module 10 without lateral play such that lateral (i.e., axial) displacement of the pump module 10 lying against the counter pivot bearing 24 is prevented. The pump module 10 is subsequently rotated and tightened about the pivot axis of the bearings 17 and 24 by the tension lever until the bearing surface 12 of the pump module 10 lying against the counter pivot bearing 24 lies parallel against the bearing surface 22 of the carrier 20 thereby forming a connection between the connections 13a, 13b, 13c, and 13d and the counter connections 23a, 23b, 23c, and 23d, respectively.

The counter pivot bearing 24 can be pre-adjusted to a predetermined position via the adjusting screws by means of a reference pump module, such that later adjustment is not required when a replacement module is inserted, so long as the main axes of the laser beam 16 of the pump module 10 to be fastened have the same orientation as the main axes of the reference pump module. The tension lever induces a force component in the direction of the outgoing laser beam 16 with which the pivot bearing 17 abuts against the counter pivot bearing 24. The tension lever induces a further force component in the direction of the bearing surface 22 of the carrier 20 with which the bearing surface 12 abuts the bearing surface 22 of the carrier 20.

Thus, the counter pivot bearing 24 of the carrier 20 can be adjusted in the insertion direction 14 and/or in the distance from the bearing surface 22 of the carrier 20 and/or about an axis perpendicular to the bearing surface 22 of the carrier 20, which permits adjustment of the counter pivot bearing 24 to a predetermined position using a reference pump module. The laser beam of the fastened pump module 10 should have an orientation that is spatially unambiguously defined relative to the mechanical stop of the carrier, i.e., to the counter pivot bearing 24. Later adjustment of the pump module after insertion is not required if a pump module 10 with main axes having the same orientation as the reference pump module abuts against the counter pivot bearing 24.

The cooling connection between the carrier 20 and the module 10 required for operating the diode laser stack is realized via two supply lines. On the pump module side, these supply lines of the cooling connection 13d are formed with two undetachable seals that exert pressure on flat sealing surfaces of the counter connections 23d of the carrier 20 due to the pivot motion during insertion and locking of the pump module 10. The required sealing pressure is provided by the tension lever. The sealing surfaces of the counter connections 23d are disposed on the carrier in a plane which is lower than the plane of the current supply and data connections to prevent cooling liquid from getting onto the electronics and/or optics during replacement of the pump module.

The power supply connection between the carrier 20 and the module 10 required for operating the diode laser stack is realized on the pump module side by two flat contacts 13b that contact corresponding contact surfaces 23b on the carrier 20. The force required for exerting pressure on the flat contacts 13b is also generated by the tension lever.

The data exchange connection between the carrier 20 and the module 10 is realized by a plug whose plug parts 13a and 23a are provided on the pump module 10 and on the carrier 20, respectively. The plug parts 13a and 23a are floatingly disposed such that the beam axis of the outgoing laser beam 16 is not pre-defined. In an alternative manner, the data connection could also be realized via flat contacts.

The flowing air connection is realized by a connection opening 13c with a seal on the pump module side onto which pressure is exerted by a corresponding connection opening 23c of the carrier 20. The mechanical and electrical design of the interfaces and their arrangement exclusively on the bearing side 11 of the pump module 10 permits replacement of the pump module 10 without further auxiliary tools.

All connections and counter connections required for the supply of the pump module 10 can be provided on the bearing sides of the pump module 10 and of the carrier 20, such that all interfaces can be connected or disconnected without auxiliary means when the pump module 20 is inserted on or removed from the carrier 20. The current, coolant, flowing gas, and data connections are thereby designed such that they have no influence on the spatial alignment of the pump module 10, since their joint faces are parallel to the bearing surface, i.e., the beam axis of the pump module is not pre-defined.

The four bearing surfaces 22 of the carrier 20 are disposed along a circular arc in whose center optics 27 are provided that combine the laser beams 16 of all pump modules 10 into one common output laser beam 28 for pumping the high-performance solid state laser. Thus, the carrier 20 includes several bearing surfaces 22 that lie next to each other, in particular, like a fan, with counter connections and counter pivot bearings for receiving one pump module 10 each. These multiple bearing surfaces 22 may be disposed along a circular arc in whose center optics are provided which bundle the laser beams of all pump modules 10 fastened on the carrier 20 into one common laser beam 28.

A number of implementations have been described. Nevertheless, it will be understood that various modifications may be made. Accordingly, other embodiments are within the scope of the following claims.

1. A mounting apparatus comprising:
at least one diode laser pump module having a module bearing surface and connectors on a bearing side of the pump module;
a carrier having at least one carrier bearing surface and counter connectors on a bearing side of the carrier, wherein the module is insertable onto the carrier; and
a holder configured to hold the module bearing surface of the at least one pump module in abutment against the carrier bearing surface of the at least one carrier, such that a connection is formed between the connectors and the counter connectors.

2. The apparatus of claim 1, wherein the pump module comprises:
an outlet window at a front end of the module; and
a pivot bearing, and wherein
the carrier comprises a counter pivot bearing on which the pivot bearing of the pump module engages in the mounted state.

3. The apparatus of claim 2, wherein in that the pivot bearing of the pump module is separated from the module bearing surface of the pump module.

4. The apparatus of claim 2, wherein the pivot bearing of the pump module is formed by one or more bearing recesses in front end of the module, and wherein the counter pivot bearing of the carrier is formed by one or more swivel pins.

5. The apparatus of claim 2, wherein the counter pivot bearing of the carrier is adjustable along a direction in which the module is insertable onto the carrier, wherein the counter pivot bearing of the carrier is adjustable in its distance from the bearing surface of the carrier, and wherein the counter pivot bearing of the carrier is adjustable about an axis that extends perpendicularly to the bearing surface of the carrier.

6. The apparatus of any one of claim 1, wherein the pump module comprises a projection at its front end, and wherein the carrier comprises a corresponding recess, wherein the projection and the recess mutually engage without lateral play when the pump module is inserted onto the carrier.

7. The apparatus of claim 1, wherein the pump module comprises a recess at its front end, and wherein the carrier comprises a corresponding projection, wherein the projection and the recess mutually engage without lateral play when the pump module is inserted onto the carrier.

8. The apparatus of claims 1, wherein the connections between the connectors and counter connectors comprise:
an electric power connection for providing electrical power to the module; and
a cooling connecting for providing cooling to the to the pump module.

9. The apparatus of claim 8, wherein the connections between the connectors and the counter connectors comprise:
a flowing gas connection for providing flowing gas to the pump module; and
a data transfer connection for transferring data between the pump module and the carrier.

10. The apparatus of claim 8, wherein the cooling connection comprises:
a connector on the pump module having a seal; and
a counter connector on the carrier having a flat sealing surface,
wherein the seal is pressed against the sealing surface by the holder.

11. The apparatus of claim 9, wherein the flowing gas connection comprises:
a connector on the pump module having a seal; and
a counter connector on the carrier having a flat sealing surface,
wherein the seal is pressed against the sealing surface by the holder.

12. The apparatus of claim 8, wherein the electric power connection comprises:
a connector on the pump module having flat contacts; and
a counter connector on the carrier having flat contacts,
wherein the flat contact of the connector and the counter connector are pressed against the sealing surface by the holder.

13. The apparatus of any one of claim 9, wherein the data transfer connection comprises:
a plug on the pump module; and
a plug on the carrier, wherein the plug on the pump module and on the carrier are floatingly disposed on the pump module and on the carrier.

14. The apparatus of claim 10, wherein the connections between the connectors and the counter connectors comprise:
a flowing gas connection for providing flowing gas to the pump module; and
a data transfer connection for transferring data between the pump module and the carrier, and
wherein the connector of the cooling connection is provided on the bearing side of the pump module in a plane that is lower than a plane in which the connector of the data transfer connection and the current supply connectors are provided.

15. The apparatus of claim 2, wherein the holder comprises one or more tension levers that tension the bearing surface of the pump module into abutment against the bearing surface of the carrier.

16. The apparatus of claim 15, wherein the holder comprises a tension lever that tensions the pivot bearing of the pump module along a direction in which the pump module is inserted into the carrier against the counter pivot bearing of the carrier and that tensions the bearing surface of the pump module lying against the counter pivot bearing into abutment against the bearing surface of the carrier.

17. The apparatus of claim 16, wherein the tension lever is supported on the carrier and engages with an end of the pump module opposite the front end of the module.

18. The apparatus of claim 1, wherein the carrier comprises a plurality of bearing surfaces located adjacent to each other, each bearing surface having counter connectors and counter pivot bearings for receiving a pump module.

19. The apparatus of claim 18, wherein the bearing surfaces are disposed along a circular arc and further comprising optics disposed within the circular arc, wherein the optics combine output laser beams from all pump modules inserted onto the carrier into one common laser beam.

20. A method of fastening a laser pump module to a carrier, wherein the laser pump module comprises a module bearing surface, recesses, and connectors on a bearing side of the pump module and the carrier comprises at least one carrier bearing surface, swivel pins, and counter connectors on a bearing side of the carrier, the method comprising:
inserting the pump module along an insertion direction onto the carrier, such that recesses of the pump module engage swivel pins of the carrier to locate the pump module in a pre-determined position on the carrier; and
engaging a holder to hold the module bearing surface of the pump module in abutment against the carrier bearing surface of the at least one carrier, such that connections are formed between the connectors and the counter connectors.
